(19) United States
(12) Patent Application Publication
(10) Pub. No.: US 2003/0115559 A1
(43) Pub. Date: Jun. 19, 2003

(54) Hardware validation through binary decision diagrams including functions and equalities

(75) Inventor: Jun Sawada, Austin, TX (US)

Correspondence Address: Duke W. Yee,, Carstens, Yee & Cahoon, LLP, P.O. Box 802334, Dallas, TX, 75380, US

(73) Assignee: International Business Machines Corporation, Armonk, NY

(21) Appl. No.: 10/015,224

(22) Filed: Dec. 13, 2001

(51) Int. Cl. G06F 17/50; G06F 7/60; G06F 17/10

(52) U.S. Cl. 716/5; 703/2

(57) ABSTRACT

A method, computer program product, and data processing system for validating a hardware design using Binary Decision Diagrams (BDDs) containing equalities and function symbols is disclosed. A hardware design is modeled in the logic of uninterpreted functions and an expression is created that represents an equality between an expression representing a state of the modeled design and another expression representing the desired state of the design. The equality is if-lifted to produce an expression representing a BDD. An ordering relation allowing atomic terms and function symbols to be compared is established. This ordering relation is used to repeatedly and exhaustively apply a series of transformation rules to the BDD. If and only if the BDD represents a tautology (i.e., the design is correct), only a single node representing a “true” value will remain.

### BACKGROUND OF THE INVENTION

1. Technical Field

The present invention relates generally to the validation of digital hardware designs using formal methods. Specifically, the present invention is directed toward minimizing logic expressions in the logic of uninterpreted functions to determine whether a given expression (representing an equivalence between a given design and its intended result) is a tautology.

2. Description of Related Art

There are two basic approaches to verifying that a hardware design performs properly. One is testing and/or simulation of the design. In testing or simulation, a real or simulated hardware design is subjected to a set of inputs. The resulting behavior of the design is then observed to see if it comports with the desired behavior of the device under the given set of inputs. This method of design verification, while it can often detect many of the errors in a given design, it is not foolproof. It is impractical to test or simulate every conceivable set of inputs that might be observed in practice. Thus, in all but the most trivial designs, testing and/or simulation are insufficient to determine with certainty that a design is correct.

Validation, on the other hand, involves proving mathematically that a design is correct. A design is converted into a logical formula and the properties of the logic in which the formula is written are used to prove that the formula representing the design is equivalent to a formula representing the desired result.

Jerry R. Burch and David L. Dill, “Automatic Verification of Pipelined Microprocessor Control,” Computer-Aided Verification (CAV '94), Lecture Notes on Computer Science, vol. 818, pp. 68-80, Springer Verlag (1994), which is incorporated herein by reference, describes a “logic of uninterpreted functions,” which has been used to verify both hardware and software designs. This logic of uninterpreted functions operates on Boolean logic values and includes function symbols (as in first order logic), an equality operator, and an if-then-else operator. The if-then-else operator, ite(x,y,z), tests “x” for its truth value. If x is true, then the if-then-else operation evaluates to “y,” otherwise it evaluates to “z.” Those skilled in the art of computer programming will recognize that the if-then-else operator functions in the same way as the ternary conditional operator (x ? y : z) in the C programming language. It is well known in the art that hardware designs of arbitrary complexity may be expressed in terms of the logic of interpreted functions.

Binary Decision Diagrams (BDDs) are described in R. K. Bryant, “Graph-based Algorithms for Boolean Function Manipulation,” IEEE Transactions on Computers, C-35(8):677-691 (August 1986). BDDs are a well-known data structure for expressing logical expressions. A BDD is a graph (usually a tree) wherein each node (vertex) represents a formula that can result in a true or false value. Each node has a “true edge” and a “false edge,” representing the consequences of a true or false outcome of the formula, respectively. A BDD is traversed from a root node to subsequent nodes by evaluating the formula at each node and traversing the edge representing the result. Generally, a BDD will terminate by including one or more edges that lead to final results (usually true or false). BDDs are frequently used to describe logic designs and then tested for satisfiability (whether there exists a set of circumstances or inputs in which the BDD will yield a “true” response) and/or tautology (whether under all circumstances, the BDD yields a true response).

Using a technique known in the art as “if-lifting” one can convert a formula in the logic of uninterpreted functions to a form that can be expressed as a BDD containing equality conditions only. The reader will note that a BDD containing only equalities as conditions may be expressed in terms of a nested if-then-else expression wherein for each if-then-else expression ite(x,y,z), the “x” operand (representing the condition to be tested) may contain only a function symbol, a variable, or a single equality between function symbols, variables, or a combination of the two. If-lifting is done by applying the following four syntactic conversion rules, substituting the expressions on the right hand sides of the arrows for the expressions to the left of the arrows:

f(x₁, . . . , ite(c,yₖ,zₖ), . . . , xₙ) [symbol] ite(c,f(x₁, . . . , yₖ, . . . , xₙ), f(x₁, . . . ,zₖ, . . . , xₙ))

ite(c,y,z)=x [symbol] ite(c,y=x,z=x)

x=ite(c,y,z) [symbol] ite(c,x=y,x=z)

ite(ite(a,b,c),x,y) [symbol] ite(a,ite(b,x,y),ite(c,x,y))

J. F. Groote and J. C. van der Pol, “Equational Binary Decision Diagrams,” Logic for Programming and Automated Reasoning (LPAR 2000), Lecture Notes on Computer Science, vol. 1955, pp. 161-178, Springer Verlag (2000), which is incorporated herein by reference, describes a simplification algorithm for use with “Equational Ordered Binary Decision Diagrams” or “EQ-OBDDs.” EQ-OBDDs are binary diagrams wherein the condition in each node is a statement of equality containing no function symbols. The simplification algorithm involves applying a series of eight transformation rules to a BDD repeatedly until none of the rules may be applied further. At that point, the BDD will be reduced to a single “true” value if and only if the formula represented by the BDD is valid.

Groote and van der Pol's scheme, however, requires that the function symbols be eliminated from the equalities before the simplification algorithm can be applied. Although W. Ackermann, Solvable Cases of the Decision Problem, Studies in Logic and the Foundations of Mathematics, pp. 102-103, North-Holland, Amsterdam (1954) provides a technique for eliminating the function symbols, it would be preferable to have a way to eliminate this step entirely, and thus cut down the overall computation time.

### SUMMARY OF THE INVENTION

Accordingly the present invention provides a method, computer program product, and data processing system for validating a hardware design using Binary Decision Diagrams (BDDs) containing equalities and function symbols. A hardware design is modeled in the logic of uninterpreted functions and an expression is created that represents an equality between an expression representing a state of the modeled design and another expression representing the desired state of the design. The equality is if-lifted to produce an expression representing a BDD. An ordering relation allowing atomic terms and function symbols to be compared is established. This ordering relation is used to repeatedly and exhaustively apply a series of transformation rules to the BDD. If and only if the BDD represents a tautology (i.e., the design is correct), only a single node representing a “true” value will remain.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram providing an external view of a computer system in which the present invention may be implemented;

FIG. 2 is a block diagram of a computer system in which the present invention may be implemented;

FIG. 3 is a flowchart representation of an overall process of validating a hardware design in accordance with a preferred embodiment of the present invention;

FIGS. 4-10 are diagrams depicting a Binary Decision Diagram (BDD) undergoing a process of reduction in accordance with a preferred embodiment of the present invention;

FIG. 11 is a Prolog program listing providing an example embodiment of a BDD reduction process in accordance with a preferred embodiment of the present invention; and

FIG. 12 is a flowchart representation of a process of reducing a BDD containing function symbols and equalities in accordance with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

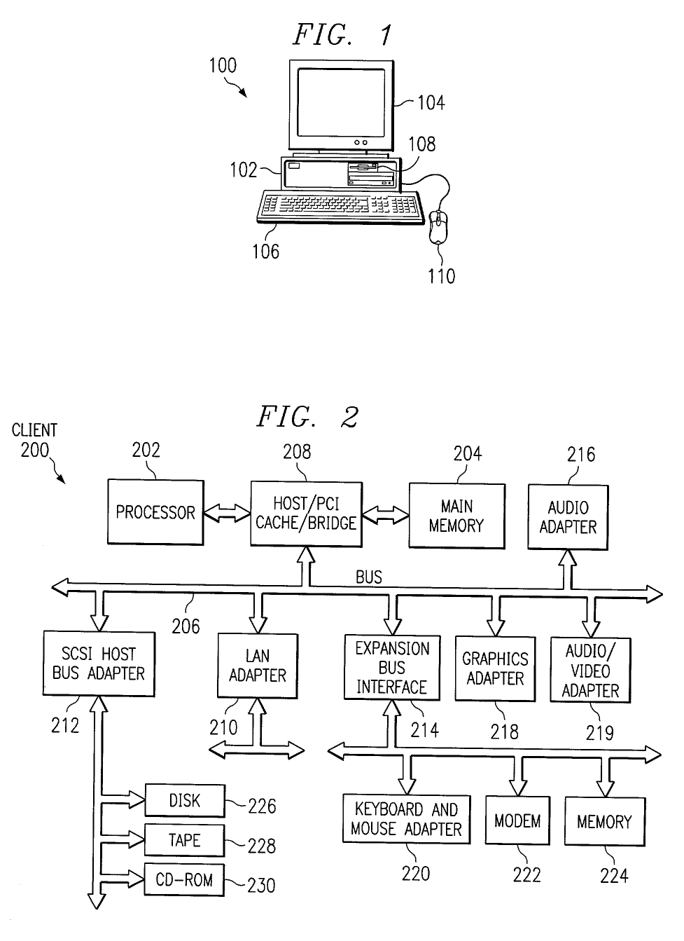

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

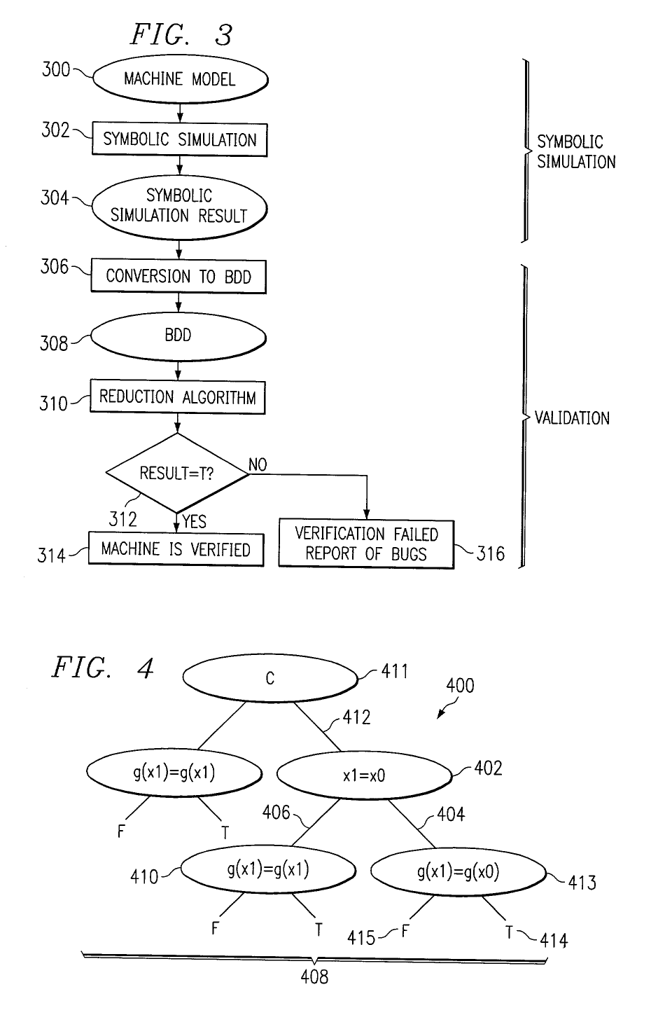

The present invention provides a method, computer program product, and data processing system for validation hardware designs through the use of Binary Decision Diagrams (BDDs) having function symbols and equalities as conditions. FIG. 3 is a flowchart representation of an overall process of validating a hardware design in accordance with a preferred embodiment of the present invention.

A machine model 300 consists of transition functions that calculate a next state of the machine being validated from a current state. These transition functions are written in the logic of uninterpreted functions described earlier in this document. Complex functional units, such as an arithmetic/logic unit (ALU) may be modeled in this way using interpreted function symbols (e.g., f(x,y,c) representing an ALU that takes inputs x and y and control signal c). Logic gates and other simpler devices may be modeled using if-then-else expressions (e.g., x AND y can be written as ite(x, y, false)).

Machine model 300 is processed through “symbolic simulation” 302 (a well-known technique in the art) to produce a result 304. “Symbolic simulation” means obtaining an expression that represents the state of the machine after a number of clock cycles. This is obtained by repeatedly applying the transition functions in machine model 300. This is best illustrated with an example.

Suppose machine model 300 contains transition functions that determine the values of three state variables, x, y, and z. As an example, suppose the functions are x:=ite(z, f(x), y), y:=x, z:=z. If initially the state variable x, y, and z, are equal to a, b, and c, respectively, so that the state of the machine may be written as a triplet (a, b, c), a first application of the transition functions will result in the new triplet (ite(c,f(a),b), a, c), which represents the state of the machine after one clock cycle. Another application of the transition functions will result in (ite(c,f(ite(c,f(a),b)),a), ite(c,f(a),b),c), which represents the state of the machine after two clock cycles, and so on.

Result 304 will consist of an expression, written in terms of the simulated machine state, that is to be verified for validity. In the above example involving x, y, and z, if we wish to verify that x and y are equivalent after two cycles of execution, result 304 will be ite(c,f(ite(c,f(a),b)),a)=ite(c,f(a),b).

Next, result 304 is converted (step 306) into a BDD 308 through the aforementioned “if-lifting” process. BDD 308 is then reduced (step 310) using an algorithm described herein. Finally, the reduced BDD is checked to see if it consists of a single “true” node (step 312). If so, then the design is verified as correct (step 314), otherwise, the verification failed (step 316).

FIG. 4 is a diagram depicting a BDD 400 containing equalities and uninterpreted function symbols. A preferred embodiment of the present invention reduces BDD 400 to a simplified form. If BDD 400 is reduced to a single “true” node, then the expression represented by BDD 400 is a tautology (and hence, the hardware design that it represents is correct).

BDD 400 is made up of nodes, such as node 402, which are connected by true edges, such as true edge 404, and false edges, such as false edge 406. (In FIG. 4 and subsequent figures, true edges extend to the right, and false edges extend to the left.) BDD 400 has a tree-like structure, and contains resulting values 408 at the leaf positions.

BDD 400 represents a nested if-then-else expression that may be evaluated by traversing the nodes. For example, starting at node 411, the root node, if “c” (a Boolean variable) is true, then we proceed along true edge 412 to node 402. If “x1=x0,” we then proceed along true edge 404 to node 413. If “g(x1)=g(x0),” we then proceed to result 414, which is “T” (true). If on the other hand, g(x1) does not equal g(x0), we proceed to result 415, which is “F” (false).

Reducing BDD 400, as described here, will determine whether the result always comes out true. To reduce BDD 400, it is necessary first to establish an ordering relation that may be used to compare logical terms (i.e., functional expressions such as f(x) and atomic terms such as x). This ordering relation can be defined in any way as long as the following two properties are met:

Condition 1: Subterm Property

If a term s appears as part of another term f( . . . ,s, . . . ), then f( . . . ,s, . . . ) is greater than s. This can be written as f( . . . ,s, . . . ) [symbol] s.

Condition 2: Monotonicity

If a term s is greater than a term t, then a term f( . . . ,s, . . . ) is greater than a term f( . . . ,t, . . . ) that replaces the occurrence of s with t. This can be written as s [symbol] t→f( . . . ,s, . . . ) [symbol] f( . . . ,t, . . . ).

One particular scheme that may be used to construct this ordering relation is as follows. First, a function “depth” is defined as below:

depth(x)=0, if x is T (true), F (false), or a variable.

depth(f (x₁,x₂, . . . ,xₙ))=max(depth(x₁),depth(x₂), . . . ,depth(xₙ))+1.

In the above definition, “max” is a function that returns the greatest of its arguments. Next, the ordering relation “ [symbol] ” is defined recursively as follows:

t [symbol] s if one of the following conditions is met:

1. depth(s)<depth(t),

2. Condition 1 is not true and if s=f(x₁,x₂, . . . , xₘ) and t=g(y₁,y₂, . . . , yₙ), then the name of the function f is lexicographically less than that of g. (A special case of this is when both s and t are variables, then t [symbol] s if the name of variable s is lexicographically less than that of t.)

3. Neither Condition 1 nor Condition 2 is true and s=f(x₁,x₂, . . . , xₘ) and t=f(y₁,y₂, . . . , yₙ), then for some k such that 1≦k≦n, if i<k then x₁=y₁, and if i=k then y₁ [symbol] x₁.

Next, an ordering relation for equalities, “ [symbol] ” is defined as follows:

s₁=t₁ [symbol] *s₂=t₂⇄max(s₁,s₂,t₁,t₂)ε{s₁,t₁}

Once the ordering relations have been established, the reduction algorithm consists of the repeated application of a series of eight transformation rules to the BDD. The algorithm terminates when no more of the rules may be applied to the expression. The rules are written below in terms of if-then-else expressions and are applied by substituting the expressions to the right of the arrows for the expressions preceding the arrows:

(1) ite(s=s,H,K) [symbol] H

(2) ite(s=t,H,K) [symbol] ite(t=s,H,K), if t [symbol] s

(3) ite(s=t,H,H) [symbol] H

(4) ite(s=t,ite(s=t,H,K),L) [symbol] ite(s=t,H,L)

(5) ite(s=t,H,ite(s=t,K,L)) [symbol] ite(s=t,H,L)

(6) ite(s₁=t₁,ite(s₂=t₂,H,K),L) [symbol] ite(s₂=t₂,ite(s₁=t₁,H,L),ite(s₁=t₁,K,L)) if s₁=t₁ [symbol] *s₂=t₂

(7) ite(s₁=t₁,H,ite(s₂=t₂,K,L)) [symbol] ite(s₂=t₂, ite(s₁=t₁,H,K),ite(s₁=t₁,H,L)), if s₁=t₁ [symbol] *s₂=t₂

(8) ite(s=t,H[s],K) [symbol] ite(s=t,H[t],K)

Some explanation of rule 8 is necessary. The change of H[s] to H[t] in rule 8 means that each occurrence of the term “s” in the expression H (which is provided as the second argument in the original if-then-else expression) is replaced by a “t.”

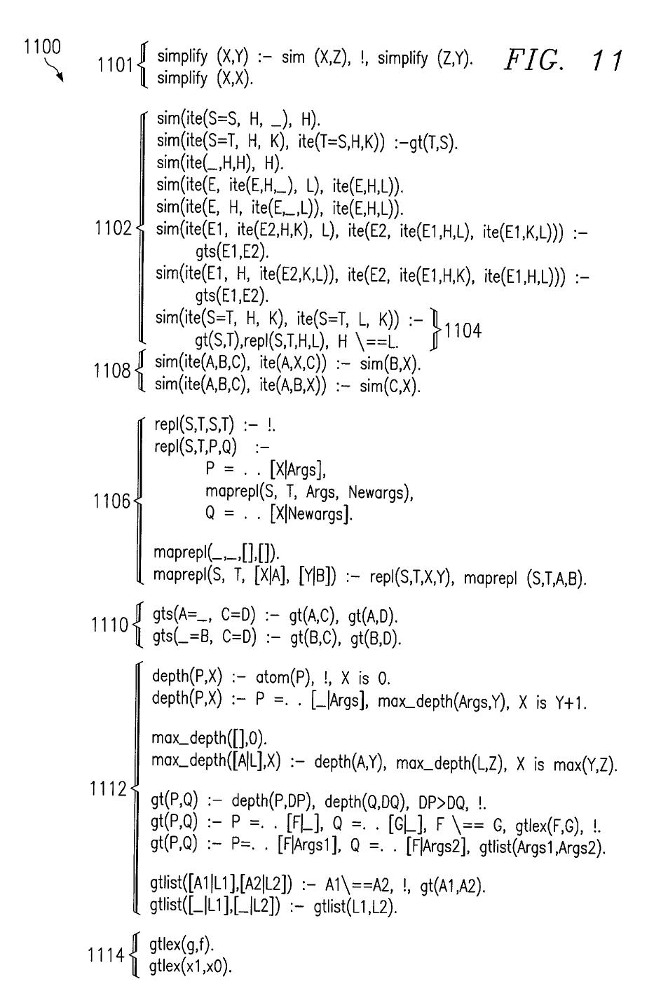

Turning now to FIGS. 4-10, once an ordering relation has been established, BDD 400 may be reduced as shown in these figures. In logical notation, BDD 400, being an expression of nested if-then-else operations, may be expressed as

ite(c,ite(x1=x0,ite(g(x1)=g(x0),T,F),ite(g(x1)=g(x1),T,F)),ite(g(x1)=g(x1),T,F)).

We can apply rules 1-8 above repeatedly to reduce this expression (or, as in the figures, the BDD graph).

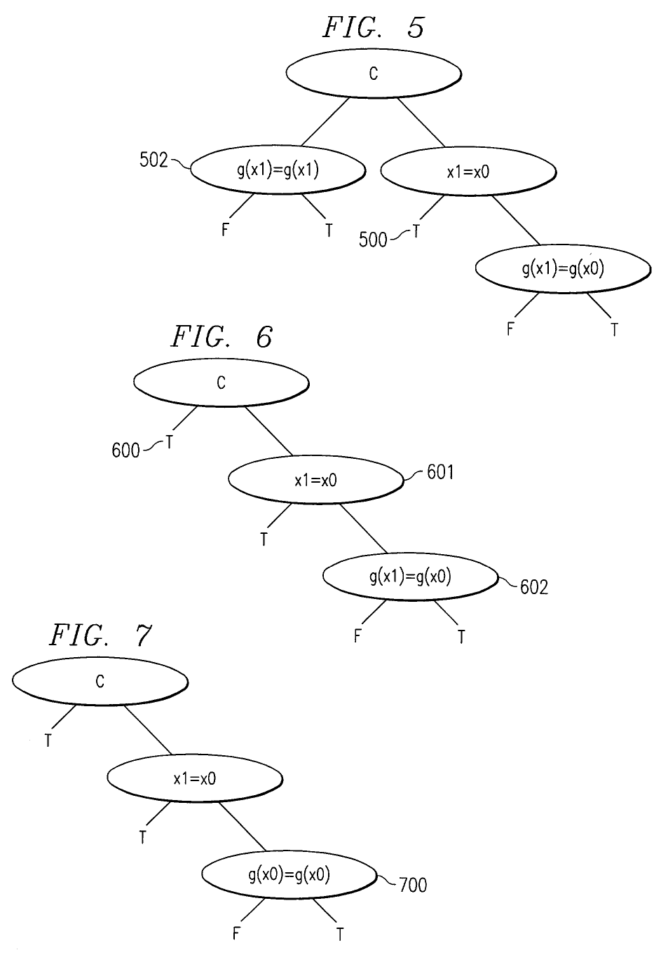

Consider first node 410. Node 410 represents an equality between two identical items. Node 410 may be expressed in logical notation as ite(g(x1)=g(x1),T,F). We can apply rule 1 to reduced node 410 to a simple “T” (true) value 500, as shown in FIG. 5. Next, consider node 502. We may apply rule 1 again to achieve “T” node 600 in FIG. 6.

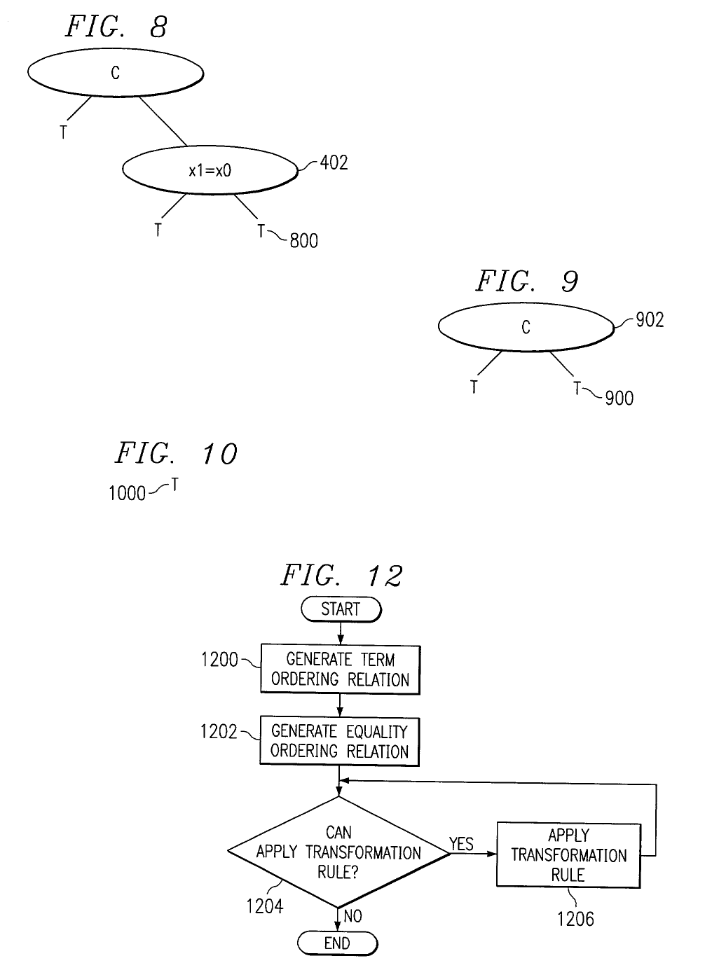

Now consider node 601. We can apply rule 8 to node 601 and its “true” child 602, substituting “x0” for “x1,” since node 601 contains the equality x1=x0. We thus modify node 602 to achieve node 700 in FIG. 7. We can then apply rule 1 to node 700 to achieve “T” node 800 in FIG. 8.

Consider node 402 in FIG. 8. Since node 402 has two identical children, we can apply rule 3 and reduce node 402 to a single “true” node 900 in FIG. 9. Finally, we can apply rule 3 to node 902 to achieve a single “T” node 1000. The algorithm terminates because no more rules can be applied. Since BDD 400 was reduced to a single “T” node 1000, we know that BDD 400 represented a tautology. In practice, this would imply that the hardware design being validated is correct.

As the BDD reduction algorithm described here in reference to FIGS. 4-10 is primarily rule-based, it lends itself well to an implementation in a logic programming language, such as Prolog. Logic programming languages such as Prolog allow programs to be written in terms of facts and rules of inference, rather than as sequences of instructions.

FIG. 11 is a diagram of a Prolog listing 1100 that contains code for reducing a BDD with function symbols and equalities, written in accordance with a preferred embodiment of the present invention. Those of ordinary skill in the art will appreciate that such a software implementation is not limited to the use of the Prolog language but may be implemented in any of a variety of computer languages, including but not limited to C, C++, Java, Fortran, Forth, Lisp, Scheme, Perl, and Assembly Languages of all kinds. It is also to be emphasized that Prolog listing 1100 is merely an example of one possible implementation of a portion the present invention, included to clarify the basic concepts underlying the invention by providing them in a concrete form. FIG. 11 should not be interpreted as limiting the invention to a particular software implementation.

Prolog listing 1100 depicts a concrete example implementation of the reduction algorithm described with respect to FIGS. 4-10. Prolog listing 1100, when executed using a suitable Prolog compiler or interpreter is capable of reducing, for example, BDD 400, when expressed in if-then-else form. Prolog listing 1100 is divided into sets of clauses, with the various clauses representing either rules or facts. A Prolog interpreter or a compiled Prolog program would make use of these rules and facts to derive a result.

Clauses 1101 represent a definition of the reduction process. They represent the rule, “To simplify a BDD, apply a transformation rule (sim) to the BDD X repeatedly until no more transformation rules can be applied, then return the resulting BDD.” Clauses 1102 represent transformation rules 1-8, respectively. Clause 1104, which represents rule 8, applies the rules in clauses 1106 to replace each occurrence of “s” with “t” in expression “H” (see rule 8, above). Clauses 1108 are rules that state that transformation rules 1-8 may be applied to child nodes as well as the root node of the BDD.

Clauses 1110 define the “ [symbol] ” relation (called “gts” in Prolog listing 1100) in terms of the “ [symbol] ” relation (called “gt” in Prolog listing 1100). Clauses 1112 define this “gt” relation using the “depth” procedure described earlier. Finally, as Prolog listing 1100 is merely an example intended to be applied to BDD 400 in FIG. 4, the “gt” relation is finished off with clause 1114, which imposes a lexicographic ordering on the variable terms x0 and x1 and function symbols f and g. In practice, the ordering relation will vary depending on the particular terms present in the BDD to be reduced, as described above.

FIG. 12 is a flowchart representation of a process of reducing a BDD containing function symbols and inequalities in accordance with a preferred embodiment of the present invention. First, an ordering relation is established that imposes an ordering on terms, including variables and functions of variables (step 1200). This ordering relation is used to generate an ordering relation for equalities (step 1202). If a transformation rule from rules 1-8 can be applied to the BDD (step 1204:Yes), then the rule is applied (step 1206) and the process cycles back to step 1204 to see if another rule can be applied. If not (step 1204:No), then the algorithm terminates.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for validating a hardware design, comprising:
applying one of a plurality of transformation rules to simplify a binary decision diagram containing function symbols and variables which represent a hardware design to be validated;
repeating the application of the plurality of transformation rules to the binary decision diagram until no more of the plurality of transformation rules may be applied to the binary decision diagram; and
in response to no more of the plurality of the transformation rules being applicable to the binary decision diagram, determining whether the binary decision diagram has been reduced to a single true value.

2. The method of claim 1, further comprising:
defining a first ordering relation on a set of terms, wherein the terms include function symbols and variables.

3. The method of claim 2, wherein the first ordering relation follows a subterm property.

4. The method of claim 2, wherein the first ordering relation follows a monotonicity property.

5. The method of claim 2, further comprising:
in response to defining the first ordering relation, defining a second ordering relation on a set of equalities, wherein the set of equalities includes equalities between terms ordered by the first ordering relation.

6. The method of claim 1, wherein the plurality of transformation rules includes mapping a node of the form ite(s=s,H,K) into a node of the form H.

7. The method of claim 1, wherein the plurality of transformation rules includes mapping a node of the form ite(s=t,H,K) into a node of the form ite(t=s,H,K) in response to a determination that t is greater than s in an ordering relation having a subterm property and a monotonicity property.

8. The method of claim 1, wherein the plurality of transformation rules includes mapping a node of the form ite(s=t,H,H) into a node of the form H.

9. The method of claim 1, wherein the plurality of transformation rules includes mapping a node of the form ite(s=t,ite(s=t,H,K),L) into a node of the form ite(s=t,H,L).

10. The method of claim 1, wherein the plurality of transformation rules includes mapping a node of the form ite(s=t,H,ite(s=t,K,L)) into a node of the form ite(s=t,H,L).

11. The method of claim 1, wherein the plurality of transformation rules includes mapping a node of the form ite(s₁=t₁,ite(s₂=t₂,H,K),L) into a node of the form ite(s₂=t₂,ite(s₁=t₁,H,L),ite(s₁=t₁,K,L)) in response to a determination that s₁=t₁ is greater than s₂ t₂ according to a pre-determined ordering relation.

12. The method of claim 1, wherein the plurality of transformation rules includes mapping a node of the form ite(s₁=t₁,H,ite(s₂=t₂,K,L)) into a node of the form ite(s₂=t₂,ite(s₁=t₁,H,K),ite(s₁=t₁,H,L)) in response to a determination that s₁=t₁ is greater than s₂=t₂ according to a pre-determined ordering relation.

13. The method of claim 1, wherein the plurality of transformation rules includes mapping a first set of nodes that are true children of a node of the form ite(s=t,H,K) into a second set of nodes that is identical to the first set of nodes except that occurrences of s in the first set of nodes are replaced by t in the second set of nodes.

14. A computer program product in a computer-readable medium for validating a hardware design, comprising functional descriptive material that when executed by a computer, enables the computer to perform acts including:
applying one of a plurality of transformation rules to simplify a binary decision diagram containing function symbols and variables which represent a hardware design to be validated;
repeating the application of the plurality of transformation rules to the binary decision diagram until no more of the plurality of transformation rules may be applied to the binary decision diagram; and
in response to no more of the plurality of the transformation rules being applicable to the binary decision diagram, determining whether the binary decision diagram has been reduced to a single true value.

15. The computer program product of claim 14, comprising additional functional descriptive material that when executed by the computer, enables the computer to perform additional acts including:
defining a first ordering relation on a set of terms, wherein the terms include function symbols and variables.

16. The computer program product of claim 15, wherein the first ordering relation follows a subterm property.

17. The computer program product of claim 15, wherein the first ordering relation follows a monotonicity property.

18. The computer program product of claim 15, comprising additional functional descriptive material that when executed by the computer, enables the computer to perform additional acts including:
in response to defining the first ordering relation, defining a second ordering relation on a set of equalities, wherein the set of equalities includes equalities between terms ordered by the first ordering relation.

19. The computer program product of claim 14, wherein the plurality of transformation rules includes mapping a node of the form ite(s=s,H,K) into a node of the form H.

20. The computer program product of claim 14, wherein the plurality of transformation rules includes mapping a node of the form ite(s=t,H,K) into a node of the form ite(t=s,H,K) in response to a determination that t is greater than s in an ordering relation having a subterm property and a monotonicity property.

21. The computer program product of claim 14, wherein the plurality of transformation rules includes mapping a node of the form ite(s=t,H,H) into a node of the form H.

22. The computer program product of claim 14, wherein the plurality of transformation rules includes mapping a node of the form ite(s=t,ite(s=t,H,K),L) into a node of the form ite(s=t,H,L).

23. The computer program product of claim 14, wherein the plurality of transformation rules includes mapping a node of the form ite(s=t,H,ite(s=t,K,L)) into a node of the form ite(s=t,H,L).

24. The computer program product of claim 14, wherein the plurality of transformation rules includes mapping a node of the form ite(s₁=t₁,ite(s₂=t₂,H,K),L) into a node of the form ite(s₂=t₂,ite(s₁=t₁,H,L),ite(s₁=t₁,K,L)) in response to a determination that s₁=t₁ is greater than s₂=t₂ according to a pre-determined ordering relation.

25. The computer program product of claim 14, wherein the plurality of transformation rules includes mapping a node of the form ite(s₁=t₁,H,ite(s₂=t₂,K,L)) into a node of the form ite(s₂=t₂,ite(s₁=t₁,H,K),ite(s₁=t₁,H,L)) in response to a determination that s₁=t₁ is greater than s₂=t₂ according to a pre-determined ordering relation.

26. The computer program product of claim 14, wherein the plurality of transformation rules includes mapping a first set of nodes that are true children of a node of the form ite(s=t,H,K) into a second set of nodes that is identical to the first set of nodes except that occurrences of s in the first set of nodes are replaced by t in the second set of nodes.

27. A data processing system for validating a hardware design, comprising:
a processing unit including at least on processor;
memory; and
a set of instructions in the memory,
wherein the processing unit executes the set of instructions to perform acts including:
applying one of a plurality of transformation rules to simplify a binary decision diagram containing function symbols and variables which represent a hardware design to be validated;
repeating the application of the plurality of transformation rules to the binary decision diagram until no more of the plurality of transformation rules may be applied to the binary decision diagram; and
in response to no more of the plurality of the transformation rules being applicable to the binary decision diagram, determining whether the binary decision diagram has been reduced to a single true value.

28. The data processing system of claim 27, wherein the processing unit executes the set of instructions to perform additional acts including:
defining a first ordering relation on a set of terms, wherein the terms include function symbols and variables.

29. The data processing system of claim 28, wherein the first ordering relation follows a subterm property.

30. The data processing system of claim 28, wherein the first ordering relation follows a monotonicity property.

31. The data processing system of claim 28, wherein the processing unit executes the set of instructions to perform additional acts including:
in response to defining the first ordering relation, defining a second ordering relation on a set of equalities, wherein the set of equalities includes equalities between terms ordered by the first ordering relation.
